(19) United States
(12) Patent Application Publication
(10) Pub. No.: US 2024/0073943 A1
(43) Pub. Date: Feb. 29, 2024

(54) CHANNEL MEASUREMENTS IN CHANNEL SENSING CONTENTION SLOTS

(71) Applicant: QUALCOMM Incorporated, San Diego, CA (US)

(72) Inventors: Siyi CHEN, Beijing (CN); Arumugam CHENDAMARAI KANNAN, San Diego, CA (US); Changlong XU, Beijing (CN); Jing SUN, San Diego, CA (US); Xiaoxia ZHANG, San Diego, CA (US)

(21) Appl. No.: 18/260,720

(22) PCT Filed: Apr. 2, 2021
(86) PCT No.: PCT/CN2021/085225

§ 371 Date: Jul. 7, 2023

(51) Int. Cl. H04W 74/08; H04B 7/06

(52) U.S. Cl. CPC H04W 74/0808; H04B 7/0686

(57) ABSTRACT

Various aspects of the present disclosure generally relate to wireless communication. In some aspects, a transmitting (Tx) node may perform a channel measurement in a channel sensing contention slot based at least in part on a measurement time, wherein the measurement time is based at least in part on one or more of a sensing bandwidth or a beam switching time. The Tx may perform, to a receiving (Rx) node, a transmission based at least in part on a value of the channel measurement satisfying a threshold. Numerous other aspects are described.

### FIELD OF THE DISCLOSURE

Aspects of the present disclosure generally relate to wireless communication and to techniques and apparatuses for channel measurements in channel sensing contention slots.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a transmitting (Tx) node includes performing a channel measurement in a channel sensing contention slot based at least in part on a measurement time, wherein the measurement time is based at least in part on one or more of a sensing bandwidth or a beam switching time; and performing, to a receiving (Rx) node, a transmission based at least in part on a value of the channel measurement satisfying a threshold.

In some aspects, a method of wireless communication performed by an Rx node includes receiving, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and transmitting, to the Tx node, a response based at least in part on the transmission received from the Tx node.

In some aspects, a Tx node for wireless communication includes a memory and one or more processors, coupled to the memory, configured to: perform a channel measurement in a channel sensing contention slot based at least in part on a measurement time, wherein the measurement time is based at least in part on one or more of a sensing bandwidth or a beam switching time; and perform, to an Rx node, a transmission based at least in part on a value of the channel measurement satisfying a threshold.

In some aspects, an Rx node for wireless communication includes a memory and one or more processors, coupled to the memory, configured to: receive, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and transmit, to the Tx node, a response based at least in part on the transmission received from the Tx node.

In some aspects, a non-transitory computer-readable medium storing a set of instructions for wireless communication includes one or more instructions that, when executed by one or more processors of a Tx node, cause the Tx node to: perform a channel measurement in a channel sensing contention slot based at least in part on a measurement time, wherein the measurement time is based at least in part on one or more of a sensing bandwidth or a beam switching time; and perform, to an Rx node, a transmission based at least in part on a value of the channel measurement satisfying a threshold.

In some aspects, a non-transitory computer-readable medium storing a set of instructions for wireless communication includes one or more instructions that, when executed by one or more processors of an Rx node, cause the Rx node to: receive, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and transmit, to the Tx node, a response based at least in part on the transmission received from the Tx node.

In some aspects, a Tx apparatus for wireless communication includes means for performing a channel measurement in a channel sensing contention slot based at least in part on a measurement time, wherein the measurement time is based at least in part on one or more of a sensing bandwidth or a beam switching time; and means for performing, to an Rx apparatus, a transmission based at least in part on a value of the channel measurement satisfying a threshold.

In some aspects, an Rx apparatus for wireless communication includes means for receiving, from a Tx apparatus, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and means for transmitting, to the Tx apparatus, a response based at least in part on the transmission received from the Tx apparatus.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of a channel sensing contention slot, in accordance with the present disclosure.

FIGS. 4-9 are diagrams illustrating examples associated with channel measurements in channel sensing contention slots, in accordance with the present disclosure.

FIGS. 10-11 are diagrams illustrating example processes associated with channel measurements in channel sensing contention slots, in accordance with the present disclosure.

FIGS. 12-13 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

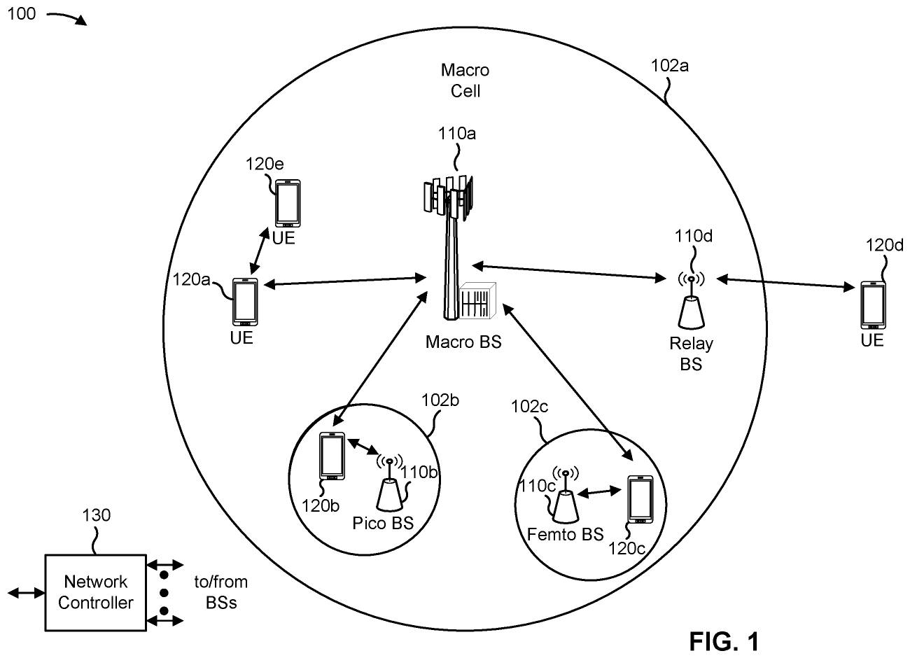

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

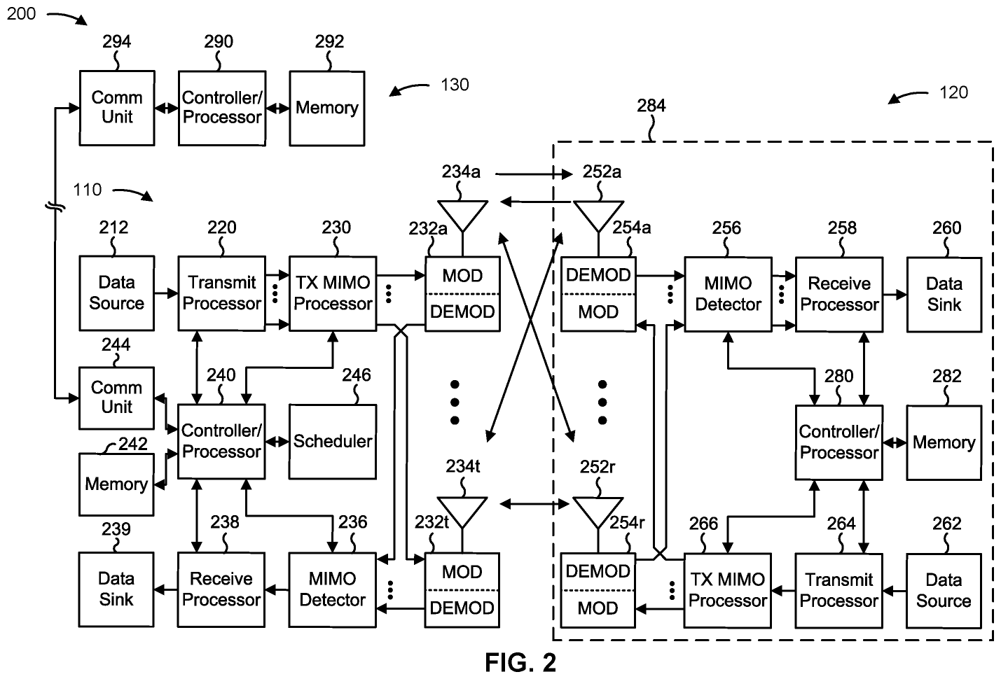

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

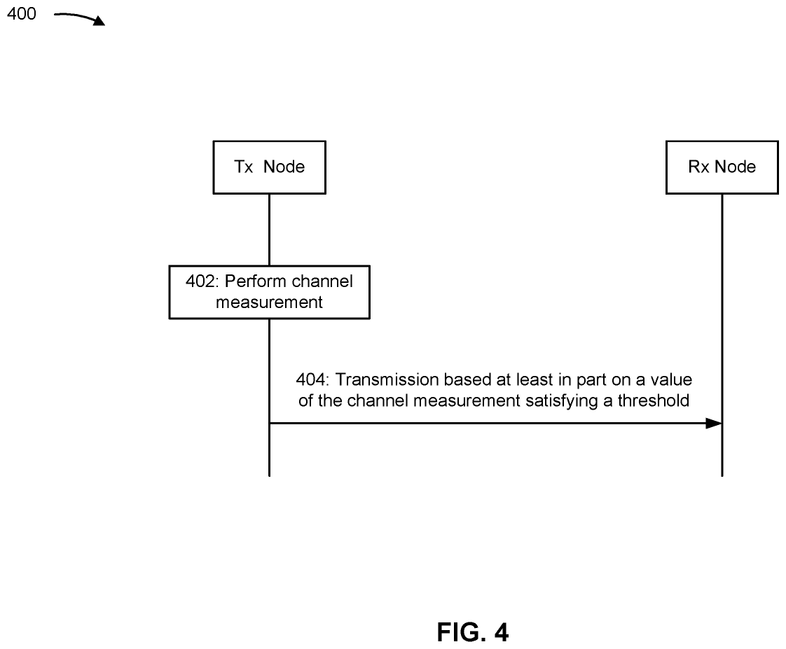

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-11).

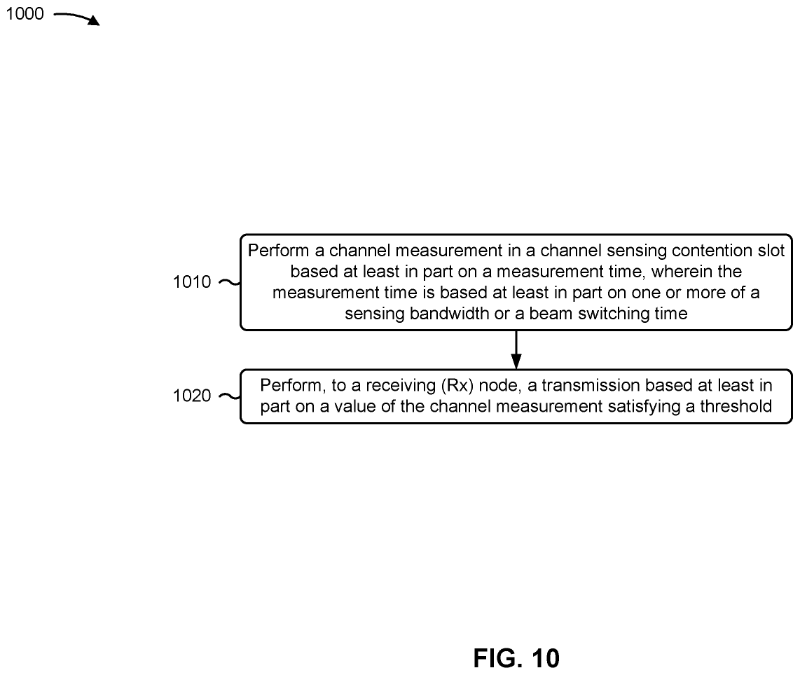

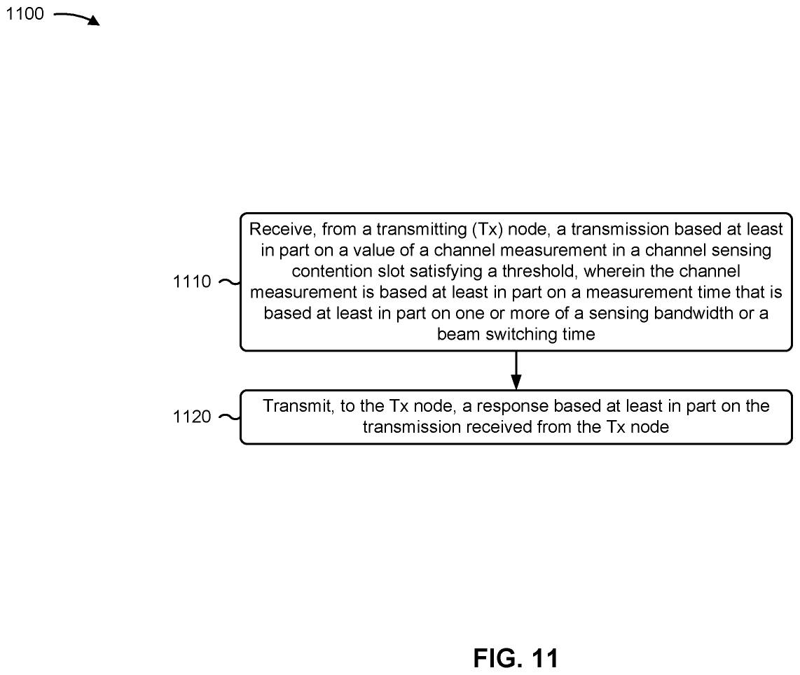

Controller/processor 240 of base station 110, controller/processor 280 of UE 120, and/or any other component(s) of FIG. 2 may perform one or more techniques associated with channel measurements in channel sensing contention slots, as described in more detail elsewhere herein. In some aspects, the Tx node and/or the Rx node described herein is the base station 110, is included in the base station 110, or includes one or more components of the base station 110 shown in FIG. 2. In some aspects, the Tx node and/or the Rx node described herein is the UE 120, is included in the UE 120, or includes one or more components of the UE 120 shown in FIG. 2. For example, controller/processor 240 of base station 110, controller/processor 280 of UE 120, and/or any other component(s) of FIG. 2 may perform or direct operations of, for example, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some aspects, executing instructions may include running the instructions, converting the instructions, compiling the instructions, and/or interpreting the instructions, among other examples.

In some aspects, a Tx node (e.g., UE 120 or base station 110) includes means for performing a channel measurement in a channel sensing contention slot based at least in part on a measurement time, wherein the measurement time is based at least in part on one or more of a sensing bandwidth or a beam switching time; and/or means for performing, to an Rx node, a transmission based at least in part on a value of the channel measurement satisfying a threshold. In some aspects, the means for the Tx node to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the Tx node to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the Tx node includes means for transmitting, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

In some aspects, an Rx node (e.g., UE 120 or base station 110) includes means for receiving, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and/or means for transmitting, to the Tx node, a response based at least in part on the transmission received from the Tx node. In some aspects, the means for the Rx node to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the Rx node to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

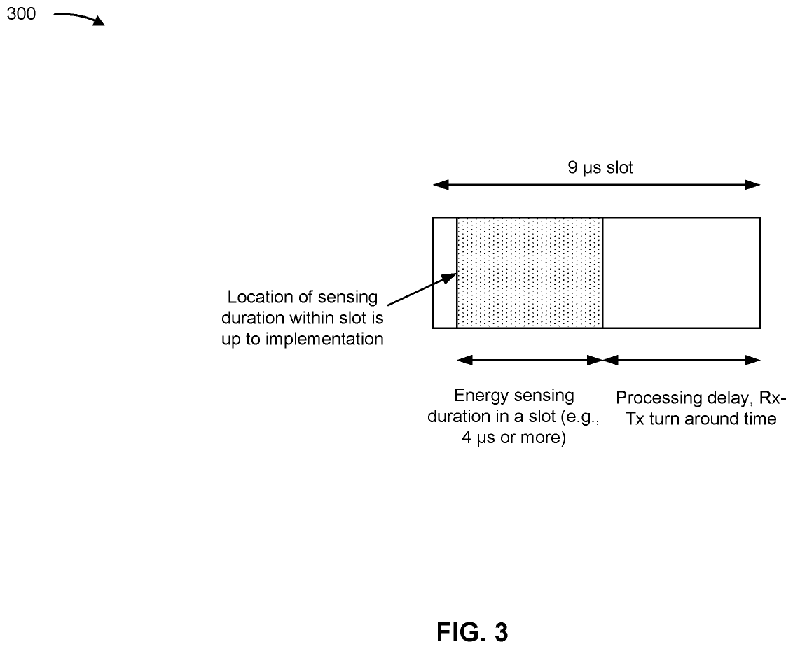

FIG. 3 is a diagram illustrating an example 300 of a channel sensing contention slot, in accordance with the present disclosure.

As shown in FIG. 3, in a 5 GHz band, a “channel sensing contention slot” may be a slot in which a sensing node performs a sensing of a channel to determine whether the channel is available. The channel sensing contention slot may have a duration of 9 microseconds (μs). The channel sensing contention slot may include an energy sensing duration. In other words, the energy sensing duration may be within the channel sensing contention slot. The energy sensing duration may be 4 μs or more within the channel sensing contention slot that spans 9 μs. A location of the energy sensing duration within the channel sensing contention slot may be flexible and up to an implementation. In other words, the location of the energy sensing duration that spans 4 μs or more may be flexible within the channel sensing contention slot that spans 9 μs. A remaining portion of the channel sensing contention slot (e.g., a duration ranging from 1 μs to 5 μs) may be allocated for processing and Rx-Tx turnaround delays.

A sensing node (e.g., a UE or a base station) may determine whether a channel sensing contention slot is busy based at least in part on the sensing node receiving energy that satisfies a threshold. The sensing node may measure the energy over the energy sensing duration of at least 4 μs within the channel sensing contention slot that spans 9 μs. The sensing node may measure or sense the energy over the energy sensing duration based at least in part on a listen-before-talk (LBT) procedure, and the channel sensing contention slot may also be referred to as an LBT contention slot. Depending on whether the energy associated with the channel sensing contention slot satisfies the threshold, the sensing node may determine that the channel is available. The sensing node may perform a transmission during a channel occupancy time that follows the channel sensing contention slot.

As indicated above, FIG. 3 is provided as an example. Other examples may differ from what is described with regard to FIG. 3.

For a 60 GHz band, the channel sensing contention slot may be 5 μs instead of 9 μs as for the 5 GHz band, so having an energy sensing duration that spans 4 μs may not be feasible as an insufficient amount of time may remain for processing delay and Rx-Tx turnaround delays. Further, a bandwidth may be variable in the 60 GHz band, unlike in the 5 GHz band. For example, the bandwidth may vary from 50 MHz to 2 GHz. With such a large range in the bandwidth, a time taken to measure energy and an Rx-Tx turnaround delay may vary depending on a sensing bandwidth. The “sensing bandwidth” may refer to a frequency range (e.g., a frequency range between 50 MHz and 2 GHz) for which measurements are captured by a sensing node. Further, due to highly directional beamforming in the 60 GHz band in relation to the 5 GHz band, a sensing beam and a transmit beam may be the same or different, which may affect a beam switching time. However, a design of a channel sensing contention slot that spans 9 μs for the 5 GHz band does not consider these factors, which are relevant to the channel sensing contention slot spanning 5 μs for the 60 GHz band.

In various aspects of techniques and apparatuses described herein, in the 60 GHz band, a larger sensing bandwidth may cause more measurement samples (e.g., as compared to the 5 GHz band), which may increase a measurement time. The measurement time may be associated with an amount of time to sense a channel (e.g., perform LBT). Further, the larger sensing bandwidth may also increase a processing time and/or an Rx-Tx turnaround time. Therefore, in some aspects, a required measurement time within a channel sensing contention slot may be a function of the sensing bandwidth.

In various aspects of techniques and apparatuses described herein, due to highly directional beamforming in the 60 GHz band, a sensing beam and a transmit beam may be the same or different, which may impact a beam switching time (e.g., a period of time to switch between the sensing beam and the transmit beam). Therefore, in some aspects, an allocated Rx-Tx turnaround time may be a function of the beam switching time, where an Rx portion of the Rx-Tx turnaround time may refer to a sensing time and a Tx portion of the Rx-Tx turnaround time may refer to a transmission time after the sensing time. In other words, the allocated Rx-Tx turnaround time may be based at least in part on the sensing time and the transmission time after the sensing time, and the allocated Rx-Tx turnaround time may be the function of the beam switching time.

In various aspects of techniques and apparatuses described herein, in an Rx-assisted LBT procedure, a base station may receive Rx-assistance information from a UE to complete the Rx-assisted LBT procedure. The base station may expect to receive the Rx-assistance information from the UE at a response time, which may be determined by the base station. However, the beam switching time may impact the determination of the response time at the base station. Thus, in some aspects, the base station may determine the response time for the Rx-assisted LBT procedure based at least in part on the beam switching time.

FIG. 4 is a diagram illustrating an example 400 of channel measurements in channel sensing contention slots, in accordance with the present disclosure. As shown in FIG. 4, example 400 includes communication between a Tx node (e.g., UE 120 or base station 110) and an Rx node (e.g., base station 110 or UE 120). In some aspects, the Tx node and the Rx node may be included in a wireless network such as wireless network 100.

As shown by reference number 402, the Tx node may perform a channel measurement in a channel sensing contention slot based at least in part on a measurement time. A “channel measurement” may be a measurement of an amount of energy associated with a channel, which may indicate whether the channel is busy (e.g., being used by another node). The channel may be associated with a frequency range (e.g., a frequency range between 50 MHz and 2 GHz), and the channel may be associated with a sensing bandwidth. The measurement time may be a listen-before-talk sensing duration. In some aspects, the measurement time may be based at least in part on the sensing bandwidth associated with the channel and/or a beam switching time.

In some aspects, the measurement time may be a first measurement time or a second measurement time. The first measurement time may be associated with a first bandwidth and may be greater than the second measurement time that is associated with a second bandwidth, and the first bandwidth may be less than the second bandwidth. Alternatively, in some aspects, the first measurement time may be associated with a first bandwidth and may be less than the second measurement time that is associated with a second bandwidth, and the first bandwidth may be less than the second bandwidth.

In some aspects, an Rx-Tx turnaround time may be based at least in part on the beam switching time. The beam switching time may be a period of time to switch between a sensing beam associated with performing the channel measurement and a transmit beam associated with performing the transmission. In some aspects, the sensing beam may be a same beam as the transmit beam, and the beam switching time and the Rx-Tx turnaround time may be less when the sensing beam and the transmit beam are the same beam as compared to the sensing beam and the transmit beam being different beams. In some aspects, the sensing beam may be a different beam than the transmit beam, and the beam switching time and the Rx-Tx turnaround time may be greater when the sensing beam and the transmit beam are different beams as compared to the sensing beam and the transmit beam being a same beam.

In some aspects, the measurement time may not be affected by the Rx-Tx turnaround time. The measurement time and the Rx-Tx turnaround time may be within a duration of the channel sensing contention slot and the measurement time may satisfy a minimum sensing duration threshold. In some aspects, the measurement time may be reduced from an initial value based at least in part on the Rx-Tx turnaround time. The measurement time and the Rx-Tx turnaround time may be within the duration of the channel sensing contention slot and the measurement time may satisfy the minimum sensing duration threshold.

In some aspects, the channel sensing contention slot may be a first channel sensing contention slot with a first duration or a second channel sensing contention slot with a second duration based at least in part on the beam switching time and the Rx-Tx turnaround time. The first channel sensing contention slot may be associated with a first energy detection threshold and a first contention window size. The second channel sensing contention slot may be associated with a second energy detection threshold and a second contention window size.

In some aspects, the Tx node may transmit, to the Rx node, Tx-Rx information that indicates the channel measurement based at least in part on a request received from the Rx node. A response time associated with transmitting the Tx-Rx information may be based at least in part on the beam switching time and whether a sensing beam is different than a transmit beam. The response time may be based at least in part on a propagation delay, the measurement time, the beam switching time, and/or a time spent transmitting the Tx-Rx information.

As shown by reference number 404, the Tx node may perform, to the Rx node, a transmission based at least in part on a value of the channel measurement satisfying a threshold. For example, the value of the channel measurement may satisfy the threshold when the channel is available.

As indicated above, FIG. 4 is provided as an example. Other examples may differ from what is described with regard to FIG. 4.

In some aspects, since a bandwidth may be flexible for the 60 GHz band, a measurement time (e.g., a required measurement time) within a channel sensing contention slot may be based at least in part on a sensing bandwidth. In other words, the measurement time may be a function of the sensing bandwidth. The measurement time may be an amount of time within a 5 μs duration associated with the channel sensing contention slot for the 60 GHz band. In some aspects, the measurement time may be a piece-wise linear function of the sensing bandwidth. Alternatively, the measurement time may be another suitable function of the sensing bandwidth.

In some aspects, a smaller measurement time may be associated with a wider bandwidth, based at least in part on switching actions being associated with relatively less time for larger bandwidths. For example, for a bandwidth of 50-1000 MHz, a measurement time may be 3 μs, and for a bandwidth of 1000-2000 MHz, a measurement time may be 2 μs. In other words, the measurement time for the wider sensing bandwidth (e.g., 1000-2000 MHz) may be less than the measurement time for the less wide sensing bandwidth (e.g., 50-1000 MHz).

In some aspects, a larger measurement time may be associated with a wider bandwidth, based at least in part on measurement actions being associated with relatively more time for larger bandwidths. For example, for a bandwidth of 50-1000 MHz, a measurement time may be 2 μs, and for a bandwidth of 1000-2000 MHz, a measurement time may be 3 μs. In other words, the measurement time for the wider sensing bandwidth (e.g., 1000-2000 MHz) may be greater than the measurement time for the less wide sensing bandwidth (e.g., 50-1000 MHz).

In some aspects, an allocated Rx-Tx turnaround time may be a function of a beam switching time. “Beam switching time” may refer to a period of time for a node (e.g., a UE or a base station) to switch from a sensing beam to a transmit beam, as the sensing beam may be different from the transmit beam due to highly directional beamforming in the 60 GHz band. The allocated Rx-Tx turnaround time may include a turnaround time between the node sensing a channel sensing contention slot and performing a transmission after the sensing. The allocated Rx-Tx turnaround time may be based at least in part on the beam switching time. For example, a higher beam switching time may lead to a higher allocated Rx-Tx turnaround time, or vice versa.

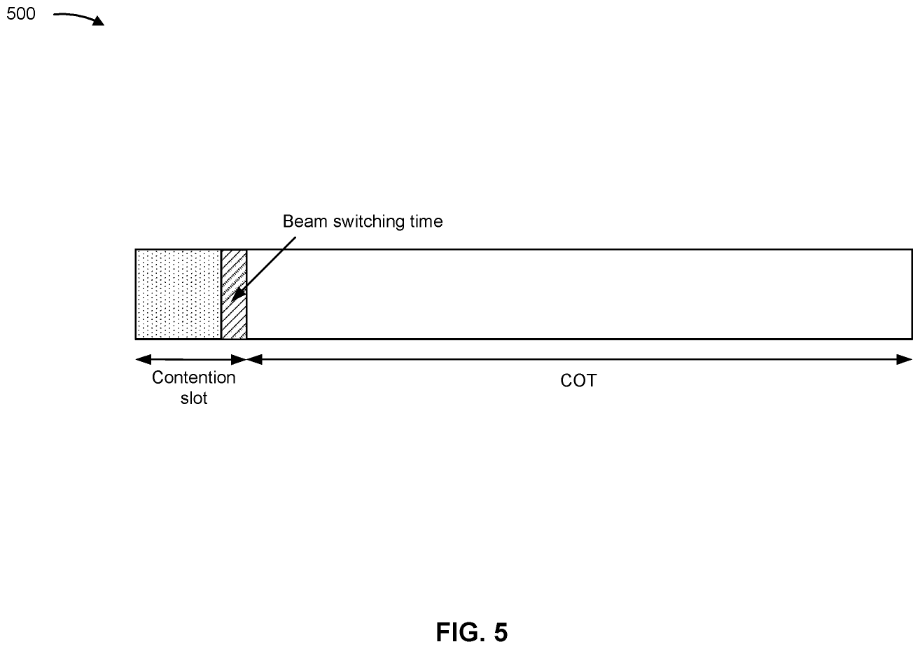

FIG. 5 is a diagram illustrating an example 500 of channel measurements in channel sensing contention slots, in accordance with the present disclosure.

As shown in FIG. 5, a channel sensing contention slot may be followed by a channel occupancy time. The channel sensing contention slot may include a measurement time (or an energy sensing duration), as well as a time duration for a processing delay and an Rx-Tx turnaround time. The time duration for the Rx-Tx turnaround time may be based at least in part on a beam switching time, which may indicate a period of time between a node performing channel sensing in the channel sensing contention slot and performing a transmission during the channel occupancy time. In some cases, the beam switching time may be relatively minimal, so the beam switching time may have a relatively small effect on the Rx-Tx turnaround time. In this case, the measurement time may not be modified due to the Rx-Tx turnaround time. For example, the measurement time and the Rx-Tx turnaround time based at least in part on the beam switching time may be within a 5 μs duration of the channel sensing contention slot, and the measurement time may be included in the channel sensing contention slot without additional modifications. In this case, the measurement time may satisfy a minimum sensing duration threshold.

As indicated above, FIG. 5 is provided as an example. Other examples may differ from what is described with regard to FIG. 5.

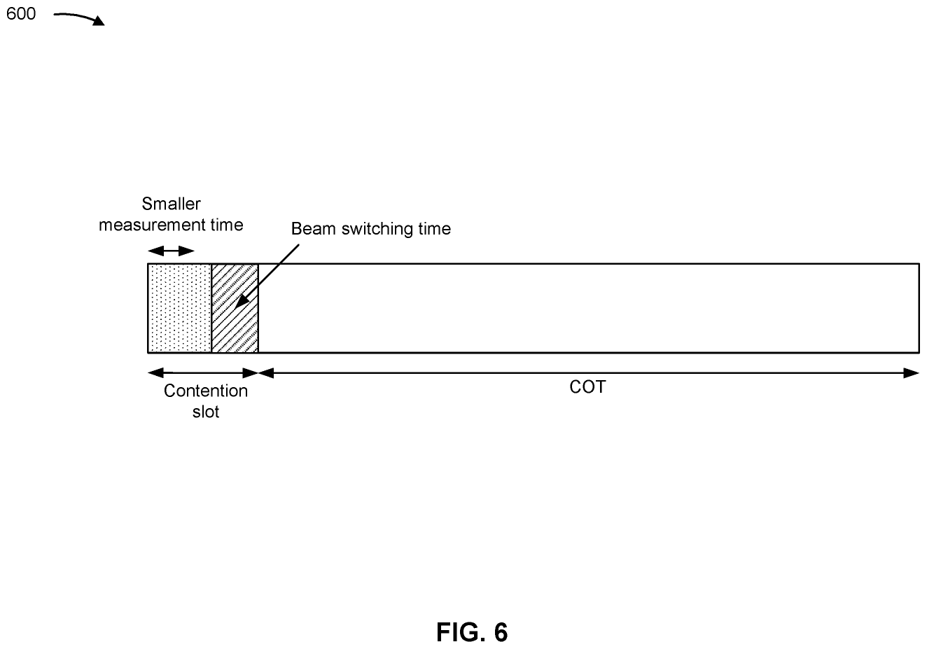

FIG. 6 is a diagram illustrating an example 600 of channel measurements in channel sensing contention slots, in accordance with the present disclosure.

As shown in FIG. 6, a channel sensing contention slot may be followed by a channel occupancy time. The channel sensing contention slot may include a measurement time (or an energy sensing duration), as well as a time duration for a processing delay and an Rx-Tx turnaround time. The time duration for the Rx-Tx turnaround time may be based at least in part on a beam switching time, which may indicate a period of time between a node performing channel sensing in the channel sensing contention slot and performing a transmission during the channel occupancy time. In some cases, the beam switching time may be relatively large based at least in part on a sensing beam being different than a transmit beam, so the beam switching time may have a relatively large effect on the Rx-Tx turnaround time. In this case, the measurement time may be reduced from an initial value due to the Rx-Tx turnaround time. In other words, the measurement time may be reduced from the initial value to account for the larger Rx-Tx turnaround time, which may be based at least in part on the larger beam switching time due to the sensing beam being different than the transmit beam. The measurement time may be reduced from the initial value such that the measurement time and the Rx-Tx turnaround time are within a 5 μs duration of the channel sensing contention slot. However, the measurement time may still satisfy a minimum sensing duration threshold.

As indicated above, FIG. 6 is provided as an example. Other examples may differ from what is described with regard to FIG. 6.

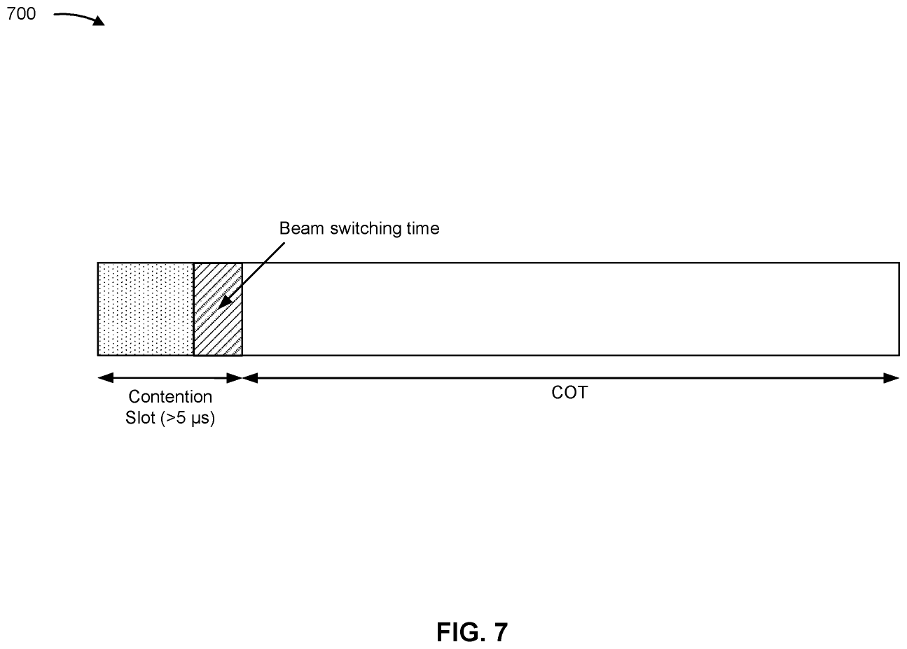

FIG. 7 is a diagram illustrating an example 700 of channel measurements in channel sensing contention slots, in accordance with the present disclosure.

As shown in FIG. 7, a measurement time and an Rx-Tx turnaround time based at least in part on a beam switching time may not be within a 5 μs duration. The beam switching time may be larger based at least in part on a sensing beam being different than a transmit beam, thereby resulting in a larger Rx-Tx turnaround time. In this case, a channel sensing contention slot may be longer than 5 μs to account for the larger Rx-Tx turnaround time. In other words, the measurement time may be unable to be reduced from an initial value to account for the larger Rx-Tx turnaround time while still satisfying a minimum sensing duration threshold, so the channel sensing contention slot may be lengthened to be more than 5 μs to accommodate the measurement time and the larger Rx-Tx turnaround time.

In some aspects, a first channel sensing contention slot may be longer than 5 μs for a beam switching time that is based at least in part on a sensing beam being different than a transmit beam. A second channel sensing contention slot that is 5 μs may be used for a beam switching time that is based at least in part on the sensing beam being the same as the transmit beam. In other words, the channel sensing contention slot may have a different duration (e.g., 5 μs or more than 5 μs) depending on the Rx-Tx turnaround time, which may be based at least in part on the beam switching time.

As indicated above, FIG. 7 is provided as an example. Other examples may differ from what is described with regard to FIG. 7.

In some aspects, a channel sensing contention slot that has a duration of 5 μs or a channel sensing contention slot that is longer than 5 μs in duration may be subjected to different requirements, such as an increased contention window (CW) size and/or different energy detection thresholds to be used when performing the channel sensing.

In some aspects, an Rx-assisted LBT procedure may involve assessing a channel clearance based at least in part on exchanging Tx-Rx information. For example, a Tx node may transmit a request to an Rx node to sense a channel. The Rx node may sense the channel and determine a clear channel assessment based at least in part on the sensing of the channel. For example, the Rx node may determine whether the channel is clear based at least in part on the sensing. The Rx node may transmit the Tx-Rx information to the Tx node that indicates the clear channel assessment. The Tx node may determine that the channel is clear based at least in part on the Tx-Rx information received from the Rx node, and the Tx node may perform a transmission to the Rx node based at least in part on the Tx-Rx information. The Tx node may expect the Tx-Rx information at a specific time based at least in part on a sensing time, processing time, and/or a turnaround time. In other words, the Tx node may estimate an amount of time for the Tx node to receive the clear channel assessment from the Rx node after sending the request to the Rx node to sense the channel.

In some aspects, for the Rx-assisted LBT procedure, a response time for receiving the Tx-Rx information may be based at least in part on a beam switching time, which may be based at least in part on an amount of time spent switching between a sensing beam and a transmit beam. In other words, the response time for receiving the Tx-Rx information may be a function of the sensing beam and the transmit beam of the receiver. In some aspects, a first response time may be defined based at least in part on the sensing beam being the same as the transmit beam, and a second response time may be defined based at least in part on the sensing beam being different than the transmit beam.

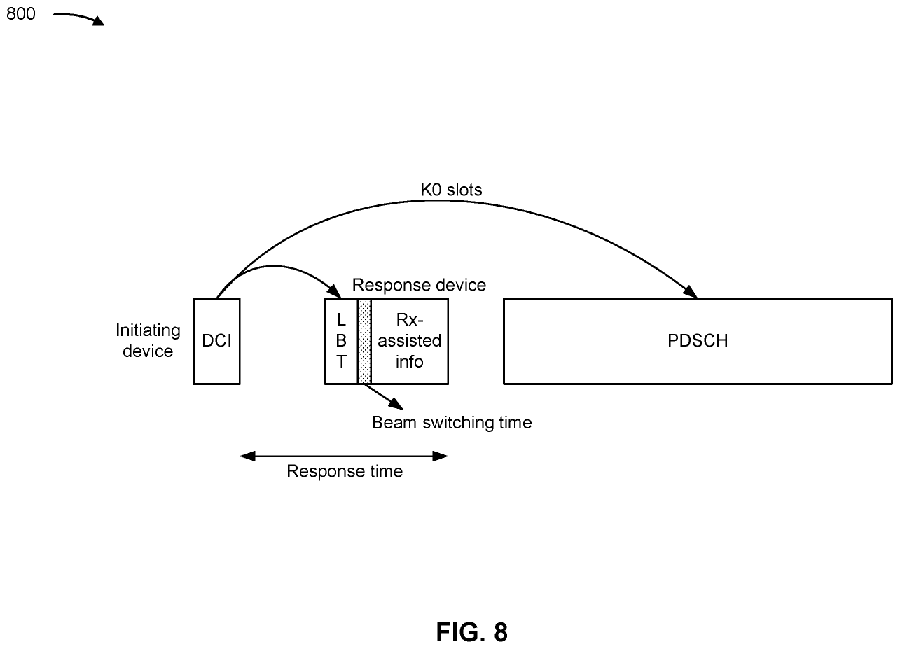

FIG. 8 is a diagram illustrating an example 800 of channel measurements in channel sensing contention slots, in accordance with the present disclosure.

As shown in FIG. 8, a Tx node (an initiating device) may transmit downlink control information (DCI). An Rx node (a response device) may sense a channel (e.g., perform LBT) based at least in part on receiving the DCI. The Rx node may sense the channel in accordance with a measurement time. The measurement time may be followed by a beam switching time, during which the Rx node may switch from a sensing beam to a transmit beam. The Rx node may transmit, after the beam switching time, Tx-Rx information to the Tx node. The Tx-Rx information may indicate whether the channel is clear based at least in part on the channel sensing. A time duration between an end of a transmission of the DCI and an end of a transmission of the Tx-Rx information may be referred to as a response time. In other words, “response time” may refer to a duration of time until the Tx node receives the Tx-Rx information from the Rx node after sending the DCI to the Rx node.

In some aspects, the beam switching time and the measurement time may be within a 5 μs duration of a channel sensing contention slot. The channel sensing contention slot may correspond to the channel sensing (e.g., LBT). The beam switching time and the measurement time may be within the 5 μs duration of the channel sensing contention slot based at least in part on the sensing beam being the same as the transmit beam. In some aspects, the response time may be based at least in part on a propagation delay, the measurement time, and a time spent transmitting the Tx-Rx information.

In some aspects, the Tx node may configure the response time based at least in part on the propagation time, the measurement time, and the time spent transmitting the Tx-Rx information. In other words, the Tx node may determine when to expect the Tx-Rx information from the Rx node based at least in part on the response time.

As indicated above, FIG. 8 is provided as an example. Other examples may differ from what is described with regard to FIG. 8.

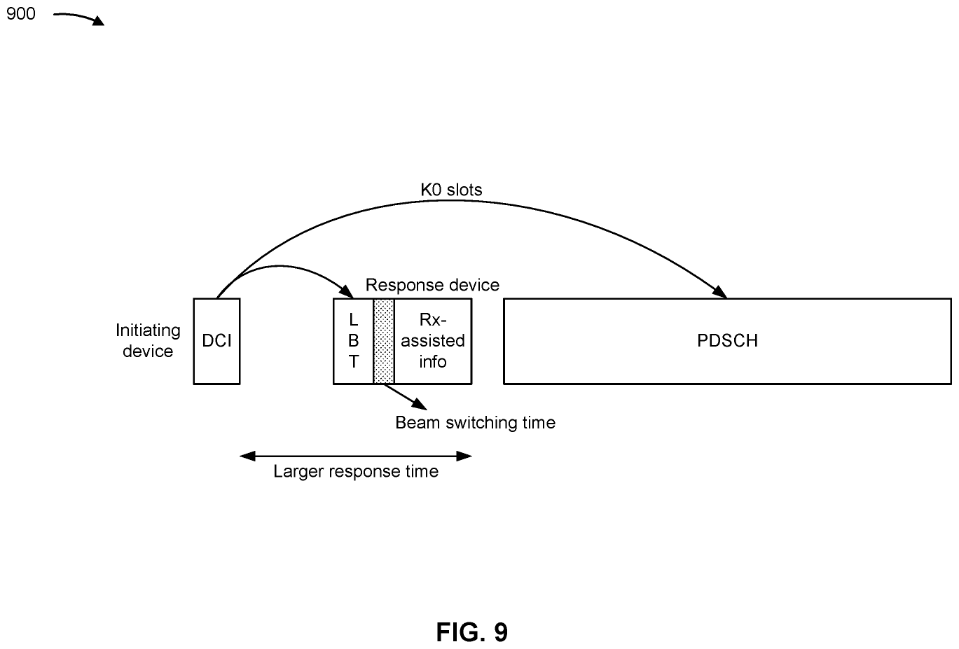

FIG. 9 is a diagram illustrating an example 900 of channel measurements in channel sensing contention slots, in accordance with the present disclosure.

As shown in FIG. 9, a beam switching time and a measurement time may fall within a channel sensing contention slot that is more than a 5 μs duration. The beam switching time and the measurement time may fall within the channel sensing contention slot that is more than the 5 μs duration based at least in part on a sensing beam being different than a transmit beam. The channel sensing contention slot may correspond to the channel sensing (e.g., LBT). In some aspects, a response time may be based at least in part on a propagation delay, the measurement time, the beam switching time, and a time spent transmitting the Tx-Rx information. In this case, the response time may be larger since the beam switching time is larger due to the sensing beam being different than the transmit beam.

In some aspects, the Tx node may configure the response time based at least in part on the propagation time, the measurement time, the beam switching time, and the time spent transmitting the Tx-Rx information. In other words, the Tx node may determine when to expect the Tx-Rx information from the Rx node based at least in part on the response time.

As indicated above, FIG. 9 is provided as an example. Other examples may differ from what is described with regard to FIG. 9.

FIG. 10 is a diagram illustrating an example process 1000 performed, for example, by a Tx node, in accordance with the present disclosure. Example process 1000 is an example where the Tx node (e.g., UE 120 or base station 110) performs operations associated with channel measurements in channel sensing contention slots.

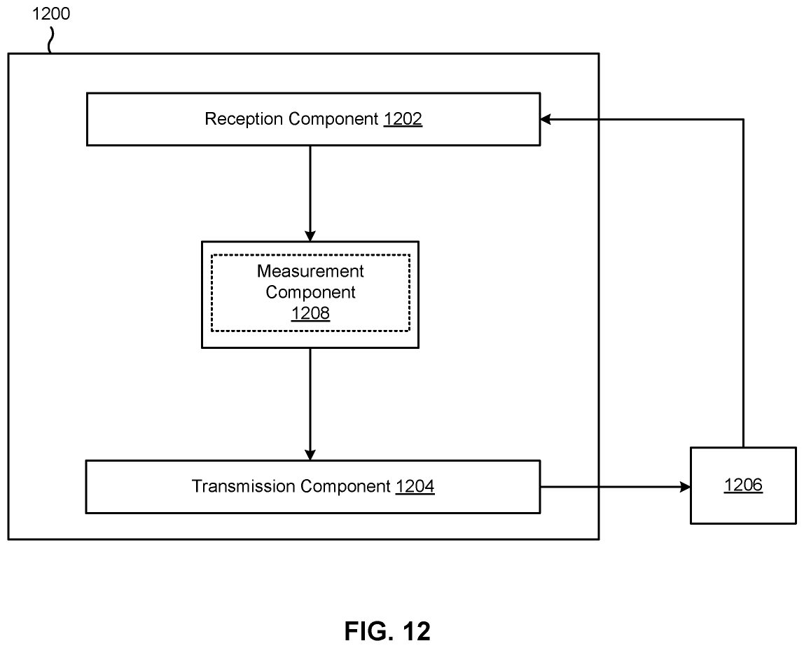

As shown in FIG. 10, in some aspects, process 1000 may include performing a channel measurement in a channel sensing contention slot based at least in part on a measurement time, wherein the measurement time is based at least in part on one or more of a sensing bandwidth or a beam switching time (block 1010). For example, the Tx node (e.g., using measurement component 1208, depicted in FIG. 12) may perform a channel measurement in a channel sensing contention slot based at least in part on a measurement time, wherein the measurement time is based at least in part on one or more of a sensing bandwidth or a beam switching time, as described above.

As further shown in FIG. 10, in some aspects, process 1000 may include performing, to an Rx node, a transmission based at least in part on a value of the channel measurement satisfying a threshold (block 1020). For example, the Tx node (e.g., using transmission component 1204, depicted in FIG. 12) may perform, to an Rx node, a transmission based at least in part on a value of the channel measurement satisfying a threshold, as described above.

Process 1000 may include additional aspects, such as any single aspect or any combination of aspects described below and/or in connection with one or more other processes described elsewhere herein.

In a first aspect, the measurement time is a listen-before-talk sensing duration.

In a second aspect, alone or in combination with the first aspect, the measurement time is one of a first measurement time or a second measurement time, wherein the first measurement time is associated with a first bandwidth and is greater than the second measurement time that is associated with a second bandwidth, wherein the first bandwidth is less than the second bandwidth, or the first measurement time is associated with a first bandwidth and is less than the second measurement time that is associated with a second bandwidth, wherein the first bandwidth is less than the second bandwidth.

In a third aspect, alone or in combination with one or more of the first and second aspects, an Rx-Tx turnaround time is based at least in part on the beam switching time, and the beam switching time is a period of time to switch between a sensing beam associated with performing the channel measurement and a transmit beam associated with performing the transmission.

In a fourth aspect, alone or in combination with one or more of the first through third aspects, the sensing beam is a same beam as the transmit beam, and the beam switching time and the Rx-Tx turnaround time are less when the sensing beam and the transmit beam are a same beam as compared to the sensing beam and the transmit beam being different beams.

In a fifth aspect, alone or in combination with one or more of the first through fourth aspects, the sensing beam is a different beam than the transmit beam, and the beam switching time and the Rx-Tx turnaround time are greater when the sensing beam and the transmit beam are different beams as compared to the sensing beam and the transmit beam being a same beam.

In a sixth aspect, alone or in combination with one or more of the first through fifth aspects, the measurement time is not affected by the Rx-Tx turnaround time, the measurement time and the Rx-Tx turnaround time are within a duration of the channel sensing contention slot, and the measurement time satisfies a minimum sensing duration threshold.

In a seventh aspect, alone or in combination with one or more of the first through sixth aspects, the measurement time is reduced from an initial value based at least in part on the Rx-Tx turnaround time, the measurement time and the Rx-Tx turnaround time are within a duration of the channel sensing contention slot, and the measurement time satisfies a minimum sensing duration threshold.

In an eighth aspect, alone or in combination with one or more of the first through seventh aspects, the channel sensing contention slot is a first channel sensing contention slot with a first duration or a second channel sensing contention slot with a second duration based at least in part on the beam switching time and the Rx-Tx turnaround time.

In a ninth aspect, alone or in combination with one or more of the first through eighth aspects, the first channel sensing contention slot is associated with a first energy detection threshold and a first contention window size, and the second channel sensing contention slot is associated with a second energy detection threshold and a second contention window size.

In a tenth aspect, alone or in combination with one or more of the first through ninth aspects, process 1000 includes transmitting, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

In an eleventh aspect, alone or in combination with one or more of the first through tenth aspects, the response time is based at least in part on one or more of a propagation delay, the measurement time, the beam switching time, or a time spent transmitting the Tx-Rx information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by an Rx node, in accordance with the present disclosure. Example process 1100 is an example where the Rx node (e.g., UE 120 or base station 110) performs operations associated with channel measurements in channel sensing contention slots.

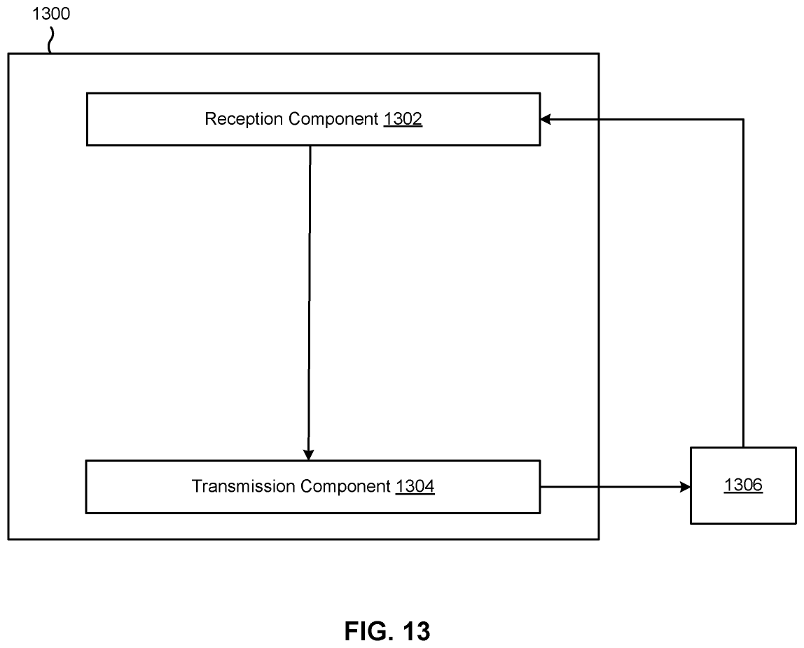

As shown in FIG. 11, in some aspects, process 1100 may include receiving, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time (block 1110). For example, the Rx node (e.g., using reception component 1302, depicted in FIG. 13) may receive, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time, as described above.

As further shown in FIG. 11, in some aspects, process 1100 may include transmitting, to the Tx node, a response based at least in part on the transmission received from the Tx node (block 1120). For example, the Rx node (e.g., using transmission component 1304, depicted in FIG. 13) may transmit, to the Tx node, a response based at least in part on the transmission received from the Tx node, as described above.

Process 1100 may include additional aspects, such as any single aspect or any combination of aspects described below and/or in connection with one or more other processes described elsewhere herein.

In a first aspect, the measurement time is one of a first measurement time or a second measurement time, wherein the first measurement time is associated with a first bandwidth and is greater than the second measurement time that is associated with a second bandwidth, wherein the first bandwidth is less than the second bandwidth, or the first measurement time is associated with a first bandwidth and is less than the second measurement time that is associated with a second bandwidth, wherein the first bandwidth is less than the second bandwidth.

In a second aspect, alone or in combination with the first aspect, the beam switching time is based at least in part on a sensing beam in relation to a transmit beam.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a Tx node, or a Tx node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a measurement component 1208, among other examples.

In some aspects, the apparatus 1200 may be configured to perform one or more operations described herein in connection with FIGS. 4-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the Tx node described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the Tx node described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the Tx node described above in connection with FIG. 2. In some aspects, the transmission component 1204 may be co-located with the reception component 1202 in a transceiver.

The measurement component 1208 may perform a channel measurement in a channel sensing contention slot based at least in part on a measurement time, wherein the measurement time is based at least in part on one or more of a sensing bandwidth or a beam switching time. The transmission component 1204 may perform, to an Rx node, a transmission based at least in part on a value of the channel measurement satisfying a threshold.

The transmission component 1204 may transmit, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a Rx node, or a Rx node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 4-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the Rx node described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the Rx node described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the Rx node described above in connection with FIG. 2. In some aspects, the transmission component 1304 may be co-located with the reception component 1302 in a transceiver.

The reception component 1302 may receive, from a Tx node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time. The transmission component 1304 may transmit, to the Tx node, a response based at least in part on the transmission received from the Tx node.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a transmitting (Tx) node, comprising: performing a channel measurement in a channel sensing contention slot based at least in part on a measurement time, wherein the measurement time is based at least in part on one or more of a sensing bandwidth or a beam switching time; and performing, to a receiving (Rx) node, a transmission based at least in part on a value of the channel measurement satisfying a threshold.

Aspect 2: The method of Aspect 1, wherein the measurement time is a listen-before-talk sensing duration.

Aspect 3: The method of any of Aspects 1 through 2, wherein the measurement time is one of a first measurement time or a second measurement time, wherein: the first measurement time is associated with a first bandwidth and is greater than the second measurement time that is associated with a second bandwidth, wherein the first bandwidth is less than the second bandwidth; or the first measurement time is associated with a first bandwidth and is less than the second measurement time that is associated with a second bandwidth, wherein the first bandwidth is less than the second bandwidth.

Aspect 4: The method of any of Aspects 1 through 3, wherein an Rx-Tx turnaround time is based at least in part on the beam switching time, and wherein the beam switching time is a period of time to switch between a sensing beam associated with performing the channel measurement and a transmit beam associated with performing the transmission.

Aspect 5: The method of Aspect 4, wherein the sensing beam is a same beam as the transmit beam, and wherein the beam switching time and the Rx-Tx turnaround time are less when the sensing beam and the transmit beam are a same beam as compared to the sensing beam and the transmit beam being different beams.

Aspect 6: The method of Aspect 4, wherein the sensing beam is a different beam than the transmit beam, and wherein the beam switching time and the Rx-Tx turnaround time are greater when the sensing beam and the transmit beam are different beams as compared to the sensing beam and the transmit beam being a same beam.

Aspect 7: The method of Aspect 4, wherein the measurement time is not affected by the Rx-Tx turnaround time, the measurement time and the Rx-Tx turnaround time are within a duration of the channel sensing contention slot, and the measurement time satisfies a minimum sensing duration threshold.

Aspect 8: The method of Aspect 4, wherein the measurement time is reduced from an initial value based at least in part on the Rx-Tx turnaround time, the measurement time and the Rx-Tx turnaround time are within a duration of the channel sensing contention slot, and the measurement time satisfies a minimum sensing duration threshold.

Aspect 9: The method of Aspect 4, wherein the channel sensing contention slot is a first channel sensing contention slot with a first duration or a second channel sensing contention slot with a second duration based at least in part on the beam switching time and the Rx-Tx turnaround time.

Aspect 10: The method of Aspect 9, wherein: the first channel sensing contention slot is associated with a first energy detection threshold and a first contention window size; and the second channel sensing contention slot is associated with a second energy detection threshold and a second contention window size.

Aspect 11: The method of any of Aspects 1 through 10, further comprising: transmitting, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

Aspect 12: The method of Aspect 11, wherein the response time is based at least in part on one or more of: a propagation delay, the measurement time, the beam switching time, or a time spent transmitting the Tx-Rx information.

Aspect 13: A method of wireless communication performed by a receiving (Rx) node, comprising: receiving, from a transmitting (Tx) node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and transmitting, to the Tx node, a response based at least in part on the transmission received from the Tx node.

Aspect 14: The method of Aspect 13, wherein the measurement time is one of a first measurement time or a second measurement time, wherein: the first measurement time is associated with a first bandwidth and is greater than the second measurement time that is associated with a second bandwidth, wherein the first bandwidth is less than the second bandwidth; or the first measurement time is associated with a first bandwidth and is less than the second measurement time that is associated with a second bandwidth, wherein the first bandwidth is less than the second bandwidth.

Aspect 15: The method of any of Aspects 13 through 14, wherein the beam switching time is based at least in part on a sensing beam in relation to a transmit beam.

Aspect 16: An apparatus for wireless communication at a device, comprising a processor; memory coupled with the processor; and instructions stored in the memory and executable by the processor to cause the apparatus to perform the method of one or more Aspects of Aspects 1-12.

Aspect 17: A device for wireless communication, comprising a memory and one or more processors coupled to the memory, the memory and the one or more processors configured to perform the method of one or more Aspects of Aspects 1-12.

Aspect 18: An apparatus for wireless communication, comprising at least one means for performing the method of one or more Aspects of Aspects 1-12.

Aspect 19: A non-transitory computer-readable medium storing code for wireless communication, the code comprising instructions executable by a processor to perform the method of one or more Aspects of Aspects 1-12.

Aspect 20: A non-transitory computer-readable medium storing a set of instructions for wireless communication, the set of instructions comprising one or more instructions that, when executed by one or more processors of a device, cause the device to perform the method of one or more Aspects of Aspects 1-12.

Aspect 21: An apparatus for wireless communication at a device, comprising a processor; memory coupled with the processor; and instructions stored in the memory and executable by the processor to cause the apparatus to perform the method of one or more Aspects of Aspects 13-15.

Aspect 22: A device for wireless communication, comprising a memory and one or more processors coupled to the memory, the memory and the one or more processors configured to perform the method of one or more Aspects of Aspects 13-15.

Aspect 23: An apparatus for wireless communication, comprising at least one means for performing the method of one or more Aspects of Aspects 13-15.

Aspect 24: A non-transitory computer-readable medium storing code for wireless communication, the code comprising instructions executable by a processor to perform the method of one or more Aspects of Aspects 13-15.

Aspect 25: A non-transitory computer-readable medium storing a set of instructions for wireless communication, the set of instructions comprising one or more instructions that, when executed by one or more processors of a device, cause the device to perform the method of one or more Aspects of Aspects 13-15.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a transmitting (Tx) node, comprising:
performing a channel measurement in a channel sensing contention slot based at least in part on a measurement time, wherein the measurement time is based at least in part on one or more of a sensing bandwidth or a beam switching time; and
performing, to a receiving (Rx) node, a transmission based at least in part on a value of the channel measurement satisfying a threshold.

2. The method of claim 1, wherein the measurement time is a listen-before-talk sensing duration.

3. The method of claim 1, wherein the measurement time is one of a first measurement time or a second measurement time, wherein:
the first measurement time is associated with a first bandwidth and is greater than the second measurement time that is associated with a second bandwidth, wherein the first bandwidth is less than the second bandwidth; or
the first measurement time is associated with a first bandwidth and is less than the second measurement time that is associated with a second bandwidth, wherein the first bandwidth is less than the second bandwidth.

4. The method of claim 1, wherein an Rx-Tx turnaround time is based at least in part on the beam switching time, and wherein the beam switching time is a period of time to switch between a sensing beam associated with performing the channel measurement and a transmit beam associated with performing the transmission.

5. The method of claim 4, wherein the sensing beam is a same beam as the transmit beam, and wherein the beam switching time and the Rx-Tx turnaround time are less when the sensing beam and the transmit beam are a same beam as compared to the sensing beam and the transmit beam being different beams.

6. The method of claim 4, wherein the sensing beam is a different beam than the transmit beam, and wherein the beam switching time and the Rx-Tx turnaround time are greater when the sensing beam and the transmit beam are different beams as compared to the sensing beam and the transmit beam being a same beam.

7. The method of claim 4, wherein the measurement time is not affected by the Rx-Tx turnaround time, the measurement time and the Rx-Tx turnaround time are within a duration of the channel sensing contention slot, and the measurement time satisfies a minimum sensing duration threshold.

8. The method of claim 4, wherein the measurement time is reduced from an initial value based at least in part on the Rx-Tx turnaround time, the measurement time and the Rx-Tx turnaround time are within a duration of the channel sensing contention slot, and the measurement time satisfies a minimum sensing duration threshold.

9. The method of claim 4, wherein the channel sensing contention slot is a first channel sensing contention slot with a first duration or a second channel sensing contention slot with a second duration based at least in part on the beam switching time and the Rx-Tx turnaround time.

10. The method of claim 9, wherein:
the first channel sensing contention slot is associated with a first energy detection threshold and a first contention window size;
and the second channel sensing contention slot is associated with a second energy detection threshold and a second contention window size.

11. The method of claim 1, further comprising:
transmitting, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

12. The method of claim 11, wherein the response time is based at least in part on one or more of: a propagation delay, the measurement time, the beam switching time, or a time spent transmitting the Tx-Rx information.

13. A method of wireless communication performed by a receiving (Rx) node, comprising:
receiving, from a transmitting (Tx) node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and
transmitting, to the Tx node, a response based at least in part on the transmission received from the Tx node.

14. The method of claim 13, wherein the measurement time is one of a first measurement time or a second measurement time, wherein:
the first measurement time is associated with a first bandwidth and is greater than the second measurement time that is associated with a second bandwidth, wherein the first bandwidth is less than the second bandwidth; or
the first measurement time is associated with a first bandwidth and is less than the second measurement time that is associated with a second bandwidth, wherein the first bandwidth is less than the second bandwidth.

15. The method of claim 13, wherein the beam switching time is based at least in part on a sensing beam in relation to a transmit beam.

16. A transmitting (Tx) node for wireless communication, comprising:
a memory; and
one or more processors, coupled to the memory, configured to:
perform a channel measurement in a channel sensing contention slot based at least in part on a measurement time, wherein the measurement time is based at least in part on one or more of a sensing bandwidth or a beam switching time; and
perform, to a receiving (Rx) node, a transmission based at least in part on a value of the channel measurement satisfying a threshold.

17. The Tx node of claim 16, wherein the measurement time is a listen-before-talk sensing duration.

18. The Tx node of claim 16, wherein the measurement time is one of a first measurement time or a second measurement time, wherein:
the first measurement time is associated with a first bandwidth and is greater than the second measurement time that is associated with a second bandwidth, wherein the first bandwidth is less than the second bandwidth; or
the first measurement time is associated with a first bandwidth and is less than the second measurement time that is associated with a second bandwidth, wherein the first bandwidth is less than the second bandwidth.

19. The Tx node of claim 16, wherein an Rx-Tx turnaround time is based at least in part on the beam switching time, and wherein the beam switching time is a period of time to switch between a sensing beam associated with performing the channel measurement and a transmit beam associated with performing the transmission.

20. The Tx node of claim 19, wherein the sensing beam is a same beam as the transmit beam, and wherein the beam switching time and the Rx-Tx turnaround time are less when the sensing beam and the transmit beam are a same beam as compared to the sensing beam and the transmit beam being different beams.

21. The Tx node of claim 19, wherein the sensing beam is a different beam than the transmit beam, and wherein the beam switching time and the Rx-Tx turnaround time are greater when the sensing beam and the transmit beam are different beams as compared to the sensing beam and the transmit beam being a same beam.

22. The Tx node of claim 19, wherein the measurement time is not affected by the Rx-Tx turnaround time, the measurement time and the Rx-Tx turnaround time are within a duration of the channel sensing contention slot, and the measurement time satisfies a minimum sensing duration threshold.

23. The Tx node of claim 19, wherein the measurement time is reduced from an initial value based at least in part on the Rx-Tx turnaround time, the measurement time and the Rx-Tx turnaround time are within a duration of the channel sensing contention slot, and the measurement time satisfies a minimum sensing duration threshold.

24. The Tx node of claim 19, wherein the channel sensing contention slot is a first channel sensing contention slot with a first duration or a second channel sensing contention slot with a second duration based at least in part on the beam switching time and the Rx-Tx turnaround time.

25. The Tx node of claim 24, wherein:
the first channel sensing contention slot is associated with a first energy detection threshold and a first contention window size;
and the second channel sensing contention slot is associated with a second energy detection threshold and a second contention window size.

26. The Tx node of claim 16, wherein the one or more processors are further configured to:
transmit, to the Rx node, Tx-Rx information that indicates the channel measurement based at least in part on a request received from the Rx node, wherein a response time associated with transmitting the Tx-Rx information is based at least in part on the beam switching time and whether a sensing beam is different than a transmit beam.

27. The Tx node of claim 26, wherein the response time is based at least in part on one or more of: a propagation delay, the measurement time, the beam switching time, or a time spent transmitting the Tx-Rx information.

28. A receiving (Rx) node for wireless communication, comprising:
a memory; and
one or more processors, coupled to the memory, configured to:
receive, from a transmitting (Tx) node, a transmission based at least in part on a value of a channel measurement in a channel sensing contention slot satisfying a threshold, wherein the channel measurement is based at least in part on a measurement time that is based at least in part on one or more of a sensing bandwidth or a beam switching time; and
transmit, to the Tx node, a response based at least in part on the transmission received from the Tx node.

29. The Rx node of claim 28, wherein the measurement time is one of a first measurement time or a second measurement time, wherein:
the first measurement time is associated with a first bandwidth and is greater than the second measurement time that is associated with a second bandwidth, wherein the first bandwidth is less than the second bandwidth; or
the first measurement time is associated with a first bandwidth and is less than the second measurement time that is associated with a second bandwidth, wherein the first bandwidth is less than the second bandwidth.

30. The Rx node of claim 28, wherein the beam switching time is based at least in part on a sensing beam in relation to a transmit beam.
